(19) United States
(12) Patent Application Publication
(10) Pub. No.: US 2013/0326035 A1
(43) Pub. Date: Dec. 5, 2013

(54) CENTRALIZED ENTERPRISE LEVEL INFRASTRUCTURE MANAGEMENT

(71) Applicants: Gordan G. Greenlee, Endicott, NY (US); Paul W. Novak, Vestal, NY (US)

(72) Inventors: Gordan G. Greenlee, Endicott, NY (US); Paul W. Novak, Vestal, NY (US)

(73) Assignee: INTERNATIONAL BUSINESS MACHINES CORPORATION, Armonk, NY (US)

(21) Appl. No.: 13/483,856

(22) Filed: May 30, 2012

(51) Int. Cl. G06F 15/173

(52) U.S. Cl. 709/223

(57) ABSTRACT

An approach is provided for managing an enterprise computer system. Management functions are coordinated from a central control point. The central control point can direct one or more agents to be deployed to establish a connection to an element in its unmodified form within the enterprise system. Agents can be directed by the central control point to establish this connection in accordance with a profile that corresponds to the element. Once the connection has been established, the agent can perform a management task with respect to the element.

### TECHNICAL FIELD

The subject matter of this invention relates generally to network management. More specifically, aspects of the present invention provide a solution for centrally managing a heterogeneous networking environment.

### BACKGROUND

In the electronic environment of today, computer systems undergo constant changes. In order to keep up with these changes, administrators of these computer systems have developed management tools. These management tools can allow administrators to view changes to the computer system and determine what implications the changes might have for the system as a whole. Currently, these management tools are installed and executed on the machines that they will be monitoring.

However, as computer systems expand to become enterprise systems, challenges occur in network management tools. Enterprise systems are designed for high volume, high availability, high redundancy, etc., and are often made up of a large number of elements. These elements may be of different types, some of which have different purposes. As such, various elements in an enterprise system can have different operating systems, middleware, applications, etc., from one another, or, in some cases, may not have readily modifiable software at all.

Because of this, monitoring systems that work on the software level, by running software loaded on a particular element, may not provide complete functionality. For example, a monitoring application that is written to function in the environment of one particular operating system may not operate on an element that executes a different operating system. Further, elements that do not have modifiable operating systems may not be able to take full advantage of such systems.

### SUMMARY

In general, aspects of the present invention provide a solution for managing an enterprise system. Management functions are coordinated from a central control point. The central control point can direct one or more agents to be deployed to establish a connection to an element in its unmodified form within the enterprise system. Agents can be directed by the central control point to establish this connection in accordance with a profile that corresponds to the element. Once the connection has been established, the agent can perform a management task with respect to the element.

A first aspect of the invention provides a method for managing an enterprise system, comprising: selecting, from a central control point, an element from among an entirety of elements in the enterprise system; selecting a profile corresponding to the element from among a plurality of profiles; deploying an agent to establish a connection to the element in an unmodified form in accordance with the profile; and performing a management task on the element using the agent.

A second aspect of the invention provides a system for managing an enterprise system, comprising: a set of agents, each agent in the set of agents connecting with an unmodified element of the enterprise system; and a central control point that directs the set of agents to connect with every element in the enterprise system to at least one of gather data from an element or perform a modification of the element.

A third aspect of the invention provides a computer program product embodied in a computer readable medium that implements a method for managing an enterprise system, the method comprising: selecting, from a central control point, an element from among an entirety of elements in the enterprise system; selecting a profile corresponding to the element from among a plurality of profiles; deploying an agent to establish a connection to the element in an unmodified form in accordance with the profile; and performing a management task on the element using the agent.

A fourth aspect of the present invention provides a method for deploying a system for managing an enterprise system, comprising, providing a computer system operable to: select, from a central control point, an element from among an entirety of elements in the enterprise system; select a profile corresponding to the element from among a plurality of profiles; deploy an agent to establish a connection to the element in an unmodified form in accordance with the profile; and perform a management task on the element using the agent.

Still yet, any of the components of the present invention could be deployed, managed, serviced, etc., by a service provider who offers to for manage an enterprise system.

Embodiments of the present invention also provide related systems, methods and/or program products.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a data processing system suitable for implementing an embodiment of the present invention.

FIG. 2 shows an enterprise environment with a central control point according to an embodiment of the invention.

FIG. 3 shows a central control point deploying an agent to establish a connection with an element according to an embodiment of the invention.

FIG. 4 shows an example flow diagram according to an embodiment of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

As indicated above, aspects of the present invention provide a solution for managing an enterprise system. Management functions are coordinated from a central control point. The central control point can direct one or more agents to be deployed to establish a connection to an element in its unmodified form within the enterprise system. Agents can be directed by the central control point to establish this connection in accordance with a profile that corresponds to the element. Once the connection has been established, the agent can perform a management task with respect to the element.

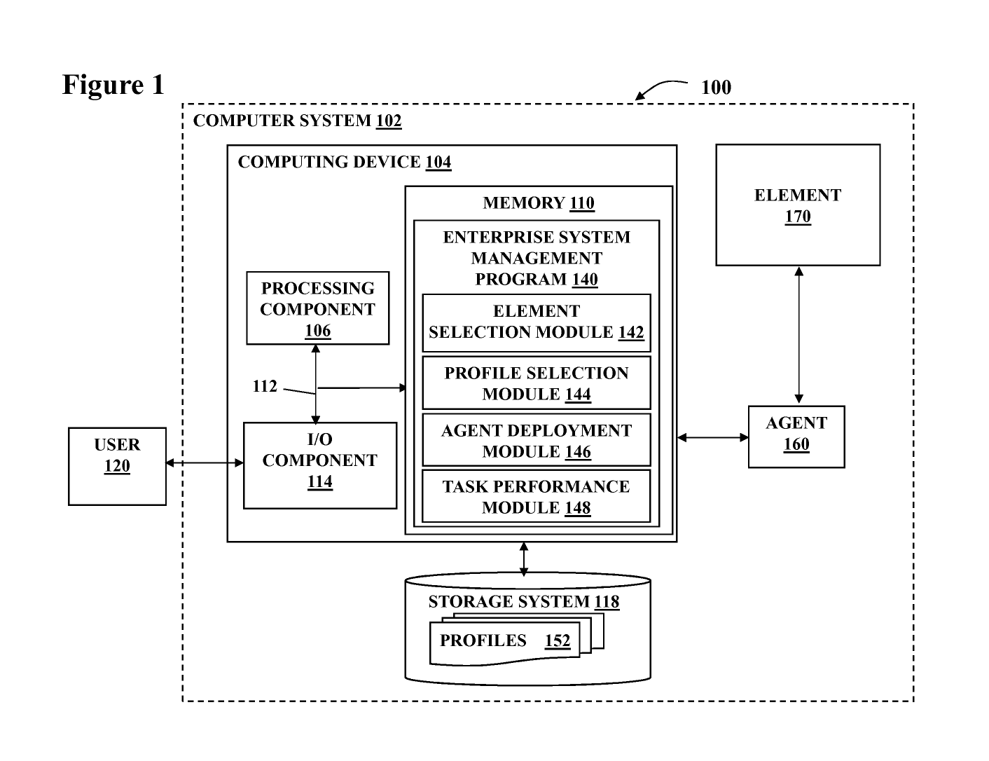

Turning to the drawings, FIG. 1 shows an illustrative environment 100 for managing an enterprise system. To this extent, environment 100 includes a computer system 102 that can perform a process described herein in order to manage an enterprise system. In particular, computer system 102 is shown including a computing device 104 that includes a enterprise system management program 140, which makes computing device 104 operable to manage an enterprise system by performing a process described herein.

Computing device 104 is shown including a processing component 106 (e.g., one or more processors), a memory 110, a storage system 118 (e.g., a storage hierarchy), an input/output (I/O) interface component 114 (e.g., one or more I/O interfaces and/or devices), and a communications pathway 112. In general, processing component 106 executes program code, such as enterprise system management program 140, which is at least partially fixed in memory 110. To this extent, processing component 106 may comprise a single processing unit, or be distributed across one or more processing units in one or more locations, e.g., on a client and server.

Memory 110 can also include local memory, employed during actual execution of the program code, bulk storage (storage 118), and/or cache memories (not shown) which provide temporary storage of at least some program code in order to reduce the number of times code must be retrieved from bulk storage 118 during execution. As such, memory 110 may comprise any known type of data storage and/or transmission media, including magnetic media, optical media, random access memory (RAM), read-only memory (ROM), a data cache, a data object, etc. Moreover, similar to processing component 116, memory 110 may reside at a single physical location, comprising one or more types of data storage, or be distributed across a plurality of physical systems in various forms.

While executing program code, processing component 106 can process data, which can result in reading and/or writing transformed data from/to memory 110 and/or I/O component 114 for further processing. Pathway 112 provides a direct or indirect communications link between each of the components in computer system 102. I/O component 114 can comprise one or more human I/O devices, which enable a human user 120 to interact with computer system 102 and/or one or more communications devices to enable a system user 120 to communicate with computer system 102 using any type of communications link.

To this extent, enterprise system management program 140 can manage a set of interfaces (e.g., graphical user interface(s), application program interface, and/or the like) that enable human and/or system users 120 to interact with enterprise system management program 140, e.g., to manage an element 170 using one or more agents 160, and/or the like. Users 120 could include enterprise system administrators, administrators of a particular element 170 and/or those who utilize the functions of element 170, among others. Further, enterprise system management program 140 can manage (e.g., store, retrieve, create, manipulate, organize, present, etc.) the data, such as one or more profiles 152, using any solution.

In any event, computer system 102 can comprise one or more general purpose computing articles of manufacture 104 (e.g., computing devices) capable of executing program code, such as enterprise system management program 140, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, enterprise system management program 140 can be embodied as any combination of system software and/or application software. In any event, the technical effect of computer system 102 is to provide processing instructions to computing device 104 in order to manage an enterprise system.

Further, enterprise system management program 140 can be implemented using a set of modules 142-148. In this case, modules 142-148 can enable computer system 102 to perform a set of tasks used by enterprise system management program 140, and can be separately developed and/or implemented apart from other portions of enterprise system management program 140. As used herein, the term “component” or “element” means any configuration of hardware, with or without software, which implements the functionality described in conjunction therewith using any solution, while the term “module” means program code that enables a computer system 102 to implement the actions described in conjunction therewith using any solution. When fixed in a memory 110 of a computer system 102 that includes a processing component 106, a module is a substantial portion of a component that implements the actions. Regardless, it is understood that two or more components, modules, and/or systems may share some/all of their respective hardware and/or software. Further, it is understood that some of the functionality discussed herein may not be implemented or additional functionality may be included as part of computer system 102.

When computer system 102 comprises multiple computing devices 104, each computing device 104 could have only a portion of enterprise system management program 140 fixed thereon (e.g., one or more modules 142-148). However, it is understood that computer system 102 and enterprise system management program 140 are only representative of various possible equivalent computer systems that may perform a process described herein. To this extent, in other embodiments, the functionality provided by computer system 102 and enterprise system management program 140 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 102 includes multiple computing devices 104, the computing devices can communicate over any type of communications link. Further, while performing a process described herein, computer system 102 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

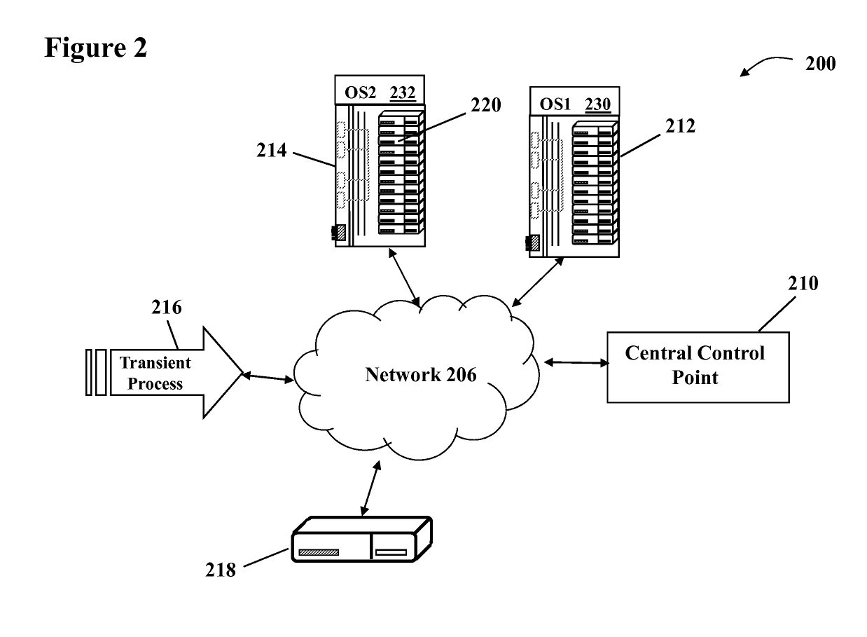

As discussed herein, enterprise system management program 140 enables computer system 102 to manage an enterprise system. To this extent, enterprise system management program 140 is shown including an element selection module 142, a profile selection module 144, an agent deployment module 146, and a task performance module 148. Element selection module 142, as executed by computer system 102, selects element 170 from among all of the elements 212-220 (FIG. 2) in enterprise environment 200.

Referring now to FIG. 2, an enterprise environment 200 according to an embodiment of the invention is shown. As shown, enterprise environment 200 includes a set of elements 212, 214, 216, 218, 220. Elements 212, 214, 216, 218, 220 can include elements of several different types. As illustrated, elements 212 and 214 are each servers, each running a different operating system 230, 232. In contrast, element 218 is an appliance that has no application software, but only hardware and firmware, and as such is not designed to be able to run external software programs. Still further, element 216 is a transient process, e.g., a process that originates from outside enterprise environment 200 but performs a task within enterprise environment 200, such as communications, network services, etc. As further shown, an element, such as server 214 can also contain one or more other elements 220 within itself, such as a device, a virtual server, a process, an appliance, etc. It should be understood that the example elements 212, 214, 216, 218, 220 shown herein are not exclusive. Rather, any element now known or later developed that can be included in an enterprise network environment is envisioned.

In any case, elements 212, 214, 216, 218, 220 in enterprise environment 200 are connected via a network 206. Network 206 can comprise any combination of various types of wired and/or wireless links; comprise any combination of one or more types of networks; and/or utilize any combination of various types of transmission techniques and protocols. Also shown in enterprise environment 200 is central control point 210. Central control point 210 can include any type of system such as computer system 102 (FIG. 1). In one embodiment, central control point 210 runs an IBM® LOTUS® DOMINO® (IBM, LOTUS and DOMINO are trademarks of International Business Machines Corp. of Armonk, N.Y. in the United States and/or other countries) database on a DOMINO® instance. As shown, central control point 210 is connected to elements 212, 214, 216, 218 and 220 through network 206.

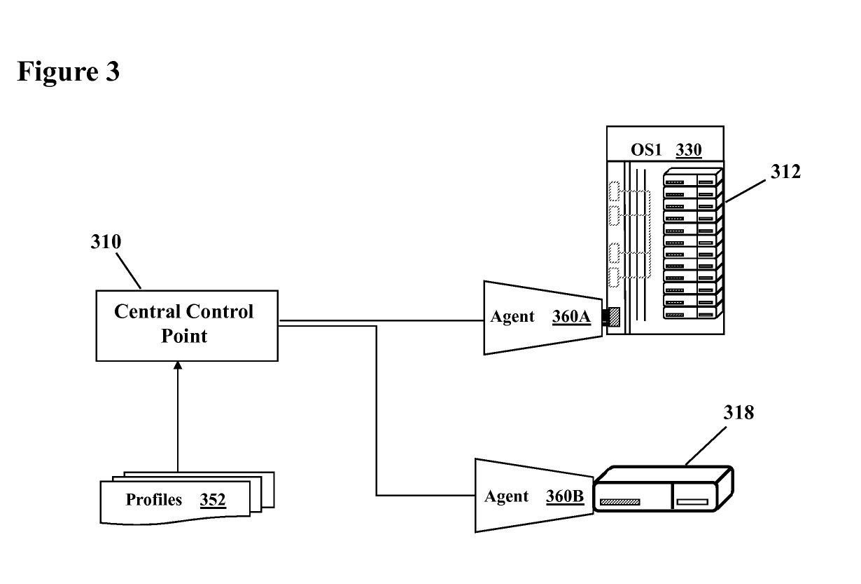

Turning now to FIG. 3, a central control point 310 deploying an agent 360A, 360B to establish a connection with an element 312, 318 according to an embodiment of the invention is shown. As shown, server element 312 and appliance element 318 have been selected by element selection module 142 (FIG. 1) from among all the elements 212, 214, 216, 218, 220 in enterprise environment 200 (FIG. 2). Selection of either or both of server element 312 or appliance element 318 can be a one-time selection based on a request from a user 120 (FIG. 1). For example, user 120 can be an administrator of enterprise environment 200 (FIG. 2) who wants to perform a single operation on one or both of server element 312 running OS 330 or appliance element 318, such as a request for a particular piece of information, a recovery operation, a purging of a log file, etc. In the alternative, user 120 can be a client user who makes a self service request via a user interface that enables the user 120 to interface with central control point 310. In this case, central control point 310 can analyze the user 120 request to insure that the request does not violate security protocols. In yet another alternative, selection of one or both of server element 312 or appliance element 318 can be made as the result of a scheduling operation. This scheduling operation can select the appropriate element 312, 318 at one or more pre-selected dates and times, or, in the alternative, can be set to select the appropriate element 312, 318 periodically at pre-selected time intervals. In still yet another alternative, selection of one or both of server element 312 or appliance element 318 can be made in response to some stimulus, such as a receipt of an error or some other event.

Turning now to FIGS. 1 and 3, concurrently, profile selection module 144, as executed by computer system 102, selects a profile 352 corresponding to element 312, 318 that has been selected by central control point 310 from among a plurality of profiles 312. In one embodiment, each time a new element 212, 214, 216, 218, 220 is discovered in enterprise environment 200 (FIG. 2), a new agent 360A-B can be deployed from central control point 310 to the element to establish a connection with the element. For example, central control point 310 could determine characteristics of the element, such as what type of element or probable types of element has been added. Central control point 310 could use this determination to provide on or more expected interfaces which the new agent 360A-B can used to connect to the element. Based on this initial connection, a new profile 352 can be generated by central control point 310. In any case, each profile 352 contains information that enables agents 360A-B to establish future connections with elements 312, 318. For example, a profile 352 can include a description of an element, including the type of element, characteristics of the element, the location of the element, and/or information about the types of interfaces the element has, and/or the like. In addition, a profile 352 can include one or more actions that can be performed by agents 360A-B on the element 312, 318, which can include monitoring, reporting, modification, restoration, etc.

Agent deployment module 146, as executed by computer system 102, deploys an agent 360A-B to establish a connection to the element 312, 318 in an unmodified form in accordance with the profile 352. This connection is established by agent 360A to element 312, 318 in an unmodified form. To this extent, agent 360A can connect to any interfaces in server element 312 that are currently available, without a need to create new interfaces and/or modify existing interfaces. These interfaces can include, for example, a log file, an ownership record, a Domain Name System (DNS), a cache in a web front end, an Secure Socket Layer (SSL) configuration, a file system utilization, an application programming interface (API) or any other component of element 312 that is available to those outside the element 312. The fact that the connection is to an element in its unmodified form makes it unnecessary for software to be written for and/or to run on any element 212, 214, 216, 218, 220 (FIG. 2) for the purposes of this context. Because no software is executing on the elements 212, 214, 216, 218, 220 (FIG. 2), themselves, connections can be made to elements 212, 214 regardless of whether differing operating systems are being employed. Further, connections can also be established with appliances 218, for which no software or modifiable application software exists.

For example, if an administrator user 120 wants to monitor a log file (not shown) in server element 312. Server element 312 can be selected by central control point 310 and a profile 352 corresponding to server element 312 can be selected from profiles 352. Central control point 352 can utilize the instructions in profile 352 to deploy agent 360A to establish a connection to server element 312. This connection can be established by agent 360A to element 312 in an unmodified form, such as through a log file interface that currently exists on server element 312. Additionally, or in the alternative, if a user 112 wants to establish a connection with appliance element 318, central control point 352 can utilize a profile corresponding to appliance element 318 to deploy agent 360B to establish a connection with appliance element 318, such as via an I/O component on appliance element 318.

Once a connection has been established, task performance module 148, as executed by computer system 102, can perform a management task on the element using the agent. This management task can include, but is not limited to, monitoring the element 312, 318 over time, gathering some reporting data from the element or performing a change to the element, and/or the like. For example, suppose, as above, an administrator user 120 knows that access to a log file may be heavy over a particular period of time and wants to monitor the log file of server element 312. Central control point 310 could deploy agent 360A to perform this monitoring. If agent 360A detected, for example, that the log file was becoming undesirably large, the agent 360A could return one or several different messages and/or reports, based on the severity. Additionally, or in the alternative, agent 360A could automatically, based on its instructions in profile 352, intervene in the process to fix the problem, such as removing a number of entries from the log file based on message type, age of the message, etc.

Additionally, or in the alternative, suppose an administrator user 120 wants to maintain synchronization among a number of elements, such as server elements 212, 214 (FIG. 2) in enterprise environment 200. Central control point 210 could select the two server elements 212, 214, select the corresponding profiles 352, and deploy agents 360A-B to establish connections with the server elements 212, 214. When a change occurred in one of the server elements 212, 214, the agent 360A-B connected to the changed server element could send a communication that informs the central control point 210 of the change. Central control point 210 could then deploy another agent to perform the synchronization on the unchanged element.

Due to the ability of agents 360A-B to connect to elements in an unmodified form, central control point 310 can use agents 360A-B to collect statistical data across a disparate mix of elements that include components, hardware, vendors, etc. This data can be used, for example, to provide alerts, to take preemptive actions to prevent outages or other problems, to take recover actions, to provide fail over servers and/or to use forensics data to identify the location of a current problem, among other things.

Additionally, the centralized nature of central control point 310 allows for central monitoring on a management station. This, combined with a user interface allows administrators to access, monitor, manage, and/or modify a large number of disparate element through a single endpoint. Additionally, the user interface allows clients to perform management requests without the need for intervention by a human administrator. Such requests could include request of management of Internet Protocol Version 4 (IPV4) addresses, request and management of Media Access Control (MAC) and Network Address Translation (NAT) IPV4 workload balancing clusters, request file permissions, etc.

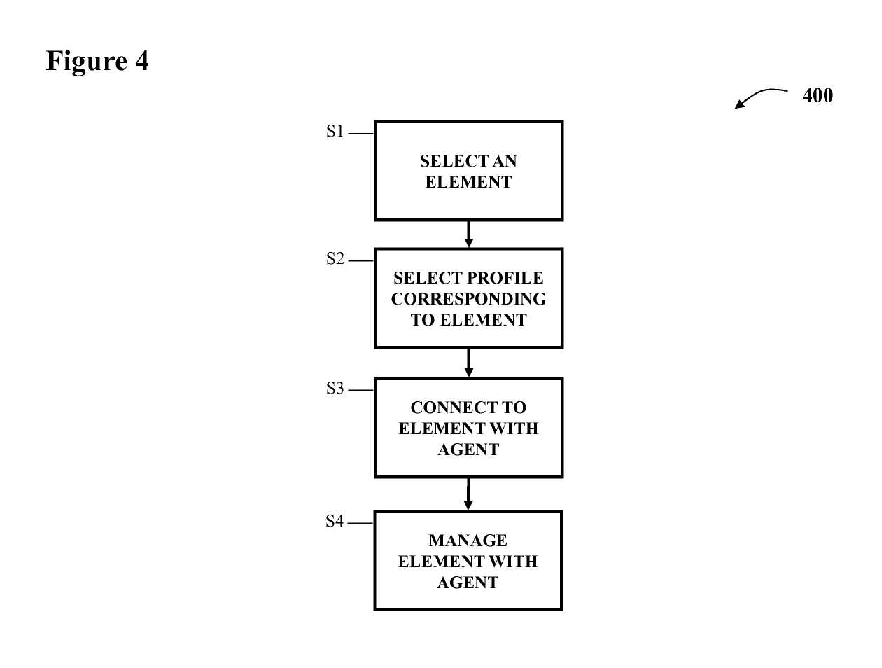

Turning now to FIG. 4, an example flow diagram according to embodiments of the invention is shown. Referring to FIG. 4 in conjunction with FIG. 1, as illustrated, in S1, element selection module 142, as executed by computer system 102, selects element 170 from among an entirety of elements 212, 214, 216, 218, 220 (FIG. 2) in enterprise system 200 (FIG. 2). This selection can be performed from a central control point 210 (FIG. 2), and can be based on such factors as input from a user 120, can be performed automatically, such as part of a scheduling operation, or the like. In S2, profile selection module 144, as executed by computer system 102, selects a profile 152 corresponding to element 170 from among a plurality of profiles 152 in storage system 118. This selection can be performed from a central control point 210 (FIG. 2). Selected profile 152 can include a set of information that enables an agent 160 to establish a connection with an element 170. To this extent, the information in selected profile 152 can be from a previous connection between an agent 160 and element 170, such as a connection established by agent 160 with element 170 when element 170 was initially discovered in enterprise system 200 (FIG. 2), or the like. In S3, agent deployment module 146, as executed by computer system 102, deploys an agent 160 to establish a connection to element 170 in an unmodified form. Agent 160 establishes the connection with element in accordance with the information in selected profile 152. To this extent, the connection can be made with an unmodified element 170, e.g., one in which no special interfaces, software, etc., need be present, but rather element can be accessed in a form in which it would have existed absent the ability to form the connection. In S4, task performance module 148, as executed by computer system 102, performs a management task on element 160 using agent 170.

While shown and described herein as a method and system for managing an enterprise system, it is understood that aspects of the invention further provide various alternative embodiments. For example, in one embodiment, the invention provides a computer program fixed in at least one computer-readable medium, which when executed, enables a computer system to manage an enterprise system. To this extent, the computer-readable medium includes program code, such as enterprise system management program 140 (FIG. 1), which implements some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; and/or the like.

In another embodiment, the invention provides a method of providing a copy of program code, such as enterprise system management program 140 (FIG. 1), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for managing an enterprise system. In this case, a computer system, such as computer system 102 (FIG. 1), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “approximately” used in connection with a quantity is inclusive of the stated value and has the meaning dictated by the context, (e.g., includes the degree of error associated with measurement of the particular quantity). The suffix “(s)” as used herein is intended to include both the singular and the plural of the term that it modifies, thereby including one or more of that term (e.g., the metal(s) includes one or more metals). Ranges disclosed herein are inclusive and independently combinable (e.g., ranges of “up to approximately 25 wt %, or, more specifically, approximately 5 wt % to approximately 20 wt %”, is inclusive of the endpoints and all intermediate values of the ranges of “approximately 5 wt % to approximately 25 wt %,” etc).

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method for managing an enterprise system, comprising:
selecting, from a central control point, an element from among an entirety of elements in the enterprise system;
selecting a profile corresponding to the element from among a plurality of profiles;
deploying an agent to establish a connection to the element in an unmodified form in accordance with the profile; and
performing a management task on the element using the agent.

2. The method of claim 1, further comprising:
discovering a new element in the enterprise system;
deploying, from the central control point, a new agent to establish a connection to the element in an unmodified form; and
generating a new profile for the new element based on the connection.

3. The method of claim 1, wherein the elements in the enterprise system include an appliance, a first computer device executing a first operating system, a second computer device executing a second operating system distinct from the first operating system, and a service that operates tangential to the enterprise system.

4. The method of claim 1, wherein the management task is selected from a group comprising: gathering reporting data from the element or performing a change to the element.

5. The method of claim 1, further comprising:
receiving a request at the central control point to perform a management task from a requestor using a central user interface; and
performing the management task indicated by the request using the agent.

6. The method of claim 1, wherein the connection is established via at least one of a log file, an ownership record, a domain name system, a cache in a web front end, an secure socket layer configuration, or a file system utilization.

7. The method of claim 1, further comprising communicating a result of the management task.

8. A system for managing an enterprise system, comprising:
a set of agents, each agent in the set of agents connecting with an unmodified element of the enterprise system; and
a central control point that directs the set of agents to connect with every element in the enterprise system to at least one of gather data from an element or perform a modification of the element.

9. The system of claim 8, further comprising a set of profiles, each profile in the set of profiles containing instructions that the central control point gives an agent to direct an action of the agent with respect to a particular element associated with the profile.

10. The system of claim 9, wherein the central control point further:
discovers a new element in the enterprise system;
deploys, from the central control point, a new agent to establish a connection to the element in an unmodified form; and
generates a new profile for the new element based on the connection.

11. The system of claim 8, wherein the elements in the enterprise system include an appliance, a first computer device executing a first operating system, a second computer device executing a second operating system distinct from the first operating system, and a service that operates tangential to the enterprise system.

12. The system of claim 8, further comprising:
a central user interface at the central control point that receives a request to perform a management task from a requestor using, wherein the set of agents perform the management task indicated by the request.

13. The system of claim 8, wherein the connection is established via at least one of a log file, an ownership record, a domain name system, a cache in a web front end, an secure socket layer configuration, or a file system utilization.

14. The system of claim 8 further, further comprising communicating a result of the management task.

15. A computer program product embodied in a computer readable medium that implements a method for managing an enterprise system, the method comprising:
selecting, from a central control point, an element from among an entirety of elements in the enterprise system;
selecting a profile corresponding to the element from among a plurality of profiles;
deploying an agent to establish a connection to the element in an unmodified form in accordance with the profile; and
performing a management task on the element using the agent.

16. The computer program product of claim 15, the method further comprising:
discovering a new element in the enterprise system;
deploying, from the central control point, a new agent to establish a connection to the element in an unmodified form; and
generating a new profile for the new element based on the connection.

17. The program product of claim 15, wherein the elements in the enterprise system include an appliance, a first computer device executing a first operating system, a second computer device executing a second operating system distinct from the first operating system, and a service that operates tangential to the enterprise system.

18. The computer program product of claim 15, the method further comprising:
receiving a request at the central control point to perform a management task from a requestor using a central user interface; and
performing the management task indicated by the request using the agent.

19. The computer program product of claim 15, the method further comprising:
initiating a disaster recovery workload on the subscription backup site to create the virtual space, the disaster recovery workload being a reduced workload that includes only critical processes; and
assigning the virtual space as the resources for allocation to the backup application.

20. The computer program product of claim 15, the method further comprising further comprising communicating a result of the management task.

21. A method for deploying a system for managing an enterprise system, comprising, providing a computer system operable to:
select, from a central control point, an element from among an entirety of elements in the enterprise system;
select a profile corresponding to the element from among a plurality of profiles;
deploy an agent to establish a connection to the element in an unmodified form in accordance with the profile; and
perform a management task on the element using the agent.
